(19) United States
(12) Patent Application Publication
(10) Pub. No.: US 2025/0382434 A1
(43) Pub. Date: Dec. 18, 2025

(54) CARBON BLACKS FOR ELASTOMERIC COMPOSITIONS

(71) Applicant: BIRLA CARBON U.S.A. INC., Marietta, GA (US)

(72) Inventors: Lewis B. Tunnicliffe, Woodstock, GA (US); Charles R. Herd, Ball Ground, GA (US)

(21) Appl. No.: 18/875,826

(22) PCT Filed: Jun. 21, 2023
(86) PCT No.: PCT/US2023/025840

§ 371 Date: Dec. 17, 2024

Related U.S. Application Data
(60) Provisional application No. 63/353,875, filed on Jun. 21, 2022.

(51) Int. Cl. C08K 3/04; C08L 7/00; C08L 9/00; C09C 1/48

(52) U.S. Cl. CPC C08K 3/04; C08L 7/00; C08L 9/00; C09C 1/48; C01P 2006/12; C01P 2006/19; C08K 2201/006

(57) ABSTRACT

Carbon black for use in elastomeric compositions for tires and other elastomeric goods. Improvements in carbon blacks are needed in the areas of material modulus, tear strength, and dynamic heat buildup. These needs and other needs are satisfied by the compositions and methods of the present disclosure. This disclosure relates to carbon blacks having surface area and structural properties that enable improved performance in elastomeric compositions such as tires.

### CROSS-REFERENCE TO RELATED APPLICATIONS

This application claims priority to U.S. Provisional Application No. 63/353,875, filed Jun. 21, 2022, the entirety of which is incorporated into this application by reference.

### TECHNICAL FIELD

This disclosure relates to carbon blacks having surface area and structural properties that enable improved performance in elastomeric compositions such as tires.

### TECHNICAL BACKGROUND

Carbon blacks have long been used in dynamic and mechanical elastomeric compositions for reinforcement purposes, but improvements are needed in the areas of material modulus, tear strength, and dynamic heat buildup. These needs and other needs are satisfied by the compositions and methods of the present disclosure.

### SUMMARY

In accordance with the purpose(s) of the disclosure, as embodied and broadly described herein, this disclosure, in one aspect, relates to carbon black, elastomeric compositions comprising carbon black, and methods for the manufacture and use thereof.

One embodiment of the carbon black exhibits the following properties: a nitrogen surface area (NSA) ranging from about 50 m²/g to about 70 m²/g; a statistical thickness surface area (STSA) ranging from about 50 m²/g to about 70 m²/g; an iodine absorption number ranging from about 50 mg/g to about 70 mg/g; an oil absorption number (OAN) ranging from about 85 cc/100 g to about 150 cc/100 g; and a compressed oil absorption number (COAN) ranging from about 70 cc/100 g to about 100 cc/100 g.

The elastomeric composition can comprise at least one elastomer together with the inventive carbon black. One embodiment of the composition comprises an elastomer in an amount of 100 parts per hundred rubber (phr); and the inventive carbon black in an amount ranging from 35 parts per hundred rubber (phr) to 75 parts per hundred rubber (phr).

### DETAILED DESCRIPTION

The present disclosure can be understood more readily by reference to the following detailed description of the invention and the Examples included therein.

Before the present carbon blacks, compositions, articles, and methods are disclosed and described, it is to be understood that they are not limited to specific synthetic methods unless otherwise specified, or to particular reagents unless otherwise specified, as such can, of course, vary. It is also to be understood that the terminology used is for the purpose of describing particular aspects only and is not intended to be limiting. Although any methods and materials similar or equivalent to those described can be used in the practice or testing of the present disclosure, example methods and materials are now described.

All publications are incorporated herein by reference to disclose and describe the methods and/or materials in connection with which the publications are cited.

### A. Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

Unless specifically stated to the contrary, the singular forms “a,” “an” and “the” include plural referents unless the context clearly dictates otherwise. Thus, for example, reference to “a carbon black” or “an elastomer” includes mixtures of two or more carbon blacks, or elastomers, respectively.

Ranges can be expressed as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed, and that each value is also disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

When the term “about” precedes a numerical value, the numerical value can vary within ±10% unless specified otherwise.

The terms “optional” or “optionally” means that the subsequently described event or circumstance can or can not occur, and that the description includes instances where said event or circumstance occurs and instances where it does not.

“Nitrogen surface area (NSA)” and “statistical thickness surface area (STSA)” refers to nitrogen surface area and statistical thickness surface area as measured according to ASTM Test Method D6556, which is incorporated by reference.

“Iodine absorption number” refers to iodine absorption values as measured according to ASTM D1510.

“Oil absorption number (OAN)” refers to oil absorption values as measured according to ASTM D2414.

“Compressed oil absorption number (COAN)” refers to compressed oil absorption values as measured according to ASTM D3493.

“325 mesh water wash residue” refers to residue values as measured according to ASTM D1514.

All the above-described ASTM methods are incorporated by reference in their entireties.

Unless specifically described otherwise, “phr” is intended to refer to parts per hundred of rubber, as commonly understood and used in the rubber industry.

“Substantially identical reference composition” refers to a composition that is in all respects substantially identical in terms of components of the composition and amount of those components in phr (within ±10%) but with the inventive carbon black replaced with ASTM N550 grade carbon black (available from Birla Carbon, Marietta, GA, USA). In a further aspect, “substantially identical reference composition” refers to a composition that is in all respects substantially identical in terms of components of the composition and amount of those components in phr (within ±5%) but with the inventive carbon black replaced with N550 grade carbon black. In a further aspect, “substantially identical reference composition” refers to a composition that is in all respects substantially identical in terms of components of the composition and amount of those components in phr (within ±2%) but with the inventive carbon black replaced with N550 grade carbon black. In a further aspect, “substantially identical reference composition” refers to a composition that is in all respects substantially identical in terms of components of the composition and amount of those components in phr (within ±1%) but with the inventive carbon black replaced with N550 grade carbon black. In a further aspect, “substantially identical reference composition” refers to a composition that is in all respects identical (within margins of measurement error) in terms of components of the composition and amount of those components in phr but with the inventive carbon black replaced with N550 grade carbon black.

ASTM N550 grade carbon black, i.e., the carbon black used in the reference composition, has the following colloidal properties measured according to the ASTM methods described above. The values listed below can vary within ±10%, ±5%, ±2%, or ±1%.

| Property | Units | Value |
|---|---|---|
| Iodine | mg/g | 43 |
| NSA | m²/g | 40 |
| STSA | m²/g | 39 |
| OAN | cc/100 g | 121 |
| COAN | cc/100 g | 85 |

Disclosed are the components to be used to prepare the compositions of the disclosure as well as the compositions themselves to be used within the methods disclosed. These and other materials are disclosed, and it is understood that when combinations, subsets, interactions, groups, etc. of these materials are disclosed that while specific reference of each various individual and collective combinations and permutation of these compounds cannot be explicitly disclosed, each is specifically contemplated and described. For example, if a particular carbon black is disclosed and discussed and a number of modifications that can be made to a number of materials including the carbon blacks are discussed, specifically contemplated is each and every combination and permutation of the carbon black and the modifications that are possible unless specifically indicated to the contrary. Thus, if a class of carbon blacks A, B, and C are disclosed as well as a class of carbon blacks D, E, and F and an example of a combination carbon black, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions. Thus, if there are a variety of additional steps that can be performed it is understood that each of these additional steps can be performed with any specific embodiment or combination of embodiments of the methods.

Each of the materials disclosed are either commercially available and/or the methods for the production thereof are known to those of skill in the art.

It is understood that the compositions disclosed have certain functions. Disclosed are certain structural requirements for performing the disclosed functions, and it is understood that there are a variety of structures that can perform the same function that are related to the disclosed structures, and that these structures will typically achieve the same result.

### B. Carbon Blacks

Carbon blacks are often used in belt and ply regions of a tire and other dynamic rubber applications. Because rubber components used in such applications typically undergo fatigue loadings and are exposed to heat, the rubber compounds should have good material modulus, tear strength, and resistance to heat buildup. ASTM N550 grade carbon black is commonly used in tire and other mechanical rubber formulations. The colloidal properties of embodiments of the carbon black described here, in comparison to N550 grade carbon black, surprisingly allow the carbon blacks to exhibit reduced heat buildup, increased tear strength, and a reduction in abrasion loss. Without wishing to be bound by theory, it is believed that the improved in-rubber properties can be attributed to the structure of the carbon blacks. Embodiments of the inventive carbon blacks (BC 2123, 2183, and 2187) have higher oil absorption and STSA values than N550, and lower STSA values compared to ASTM N330 grade carbon black.

One embodiment of the carbon black exhibits the following properties: a nitrogen surface area (NSA) ranging from about 50 m²/g to about 70 m²/g; a statistical thickness surface area (STSA) ranging from about 50 m²/g to about 70 m²/g; an iodine absorption number ranging from about 50 mg/g to about 70 mg/g; an oil absorption number (OAN) ranging from about 85 cc/100 g to about 150 cc/100 g; and a compressed oil absorption number (COAN) ranging from about 70 cc/100 g to about 100 cc/100 g.

In a further aspect, exemplary embodiments of the inventive carbon black can have a nitrogen surface area (NSA) ranging from about 55 m²/g to about 65 m²/g. In another aspect, the inventive carbon black can have a nitrogen surface area (NSA) of from about 55 to about 59 m²/g, e.g., 55 m²/g or 59 m²/g.

In one aspect, exemplary embodiments of the inventive carbon black can have a statistical thickness surface area (STSA) ranging from about 55 m²/g to about 65 m²/g. In another aspect, the inventive carbon black can have a statistical thickness surface area (STSA) of from about 53 to about 59 m²/g, e.g., 53 m²/g or 59 m²/g.

In one aspect, embodiments of the inventive carbon blacks exhibit a difference between NSA and STSA of no more than 11%, e.g., no more than 10%, no more than 9%, no more than 8%, no more than 7%, no more than 6%, no more than 5%, no more than 4%, no more than 3%, no more than 2%, or no more than 1%. In a further aspect, embodiments of the inventive carbon blacks exhibit no measurable difference (within margins of errors) between NSA and STSA.

In one aspect, exemplary embodiments of the inventive carbon black can have an iodine absorption number ranging from about 50 mg/g to about 70 mg/g. In a further aspect, exemplary embodiments of the inventive carbon black can have an iodine absorption number ranging from about 55 mg/g to about 65 mg/g. In another aspect, the inventive carbon black can have an iodine absorption number of from about 53 to about 62 mg/g.

In one aspect, embodiments of the inventive carbon blacks exhibit a difference between iodine absorption number and NSA and/or STSA of no more than 11%, e.g., no more than 10%, no more than 9%, no more than 8%, no more than 7%, no more than 6%, no more than 5%, no more than 4%, no more than 3%, no more than 2%, or no more than 1%. In a further aspect, embodiments of the inventive carbon blacks exhibit no measurable difference (within margins of errors) between iodine absorption number and NSA and/or STSA.

In one aspect, exemplary embodiments of the inventive carbon black can have an oil absorption number (OAN) ranging from about 900 cc/100 g to about 145 cc/100 g. In another aspect, exemplary embodiments of the inventive carbon black can have an oil absorption number (OAN) ranging from about 100 cc/100 g to about 135 cc/100 g. In another aspect, the inventive carbon black can have an oil absorption number of from about 120 cc/100 g to about 135 cc/100 g. In another aspect, the inventive carbon black can have an oil absorption number of from about 125 cc/100 g to about 135 cc/100 g, e.g., 127 cc/100 g or 130 cc/100 g.

In one aspect, exemplary embodiments of the inventive carbon black can have a compressed oil absorption number (COAN) ranging from about 75 cc/100 g to about 95 cc/100 g. In a further aspect, exemplary embodiments of the inventive carbon black can have a compressed oil absorption number (COAN) ranging from about 90 cc/100 g to about 95 cc/100 g.

In one aspect, exemplary embodiments of the inventive carbon black can have a 325 mesh water wash residue of less than about 650 ppm, e.g., from 300-600 ppm, e.g., 390-400 ppm, 430-440 ppm, or 600-625 ppm. In other aspects, the 325 mesh wash water residue can be lower, e.g., less than about 20 ppm, e.g., 0-19 ppm.

In one aspect, the inventive carbon black can have a transmission of from about 80% to about 100%, e.g., 80%, 97%, or 98%.

In one aspect, the inventive carbon black can have a mean aggregate size of from about 100 nm to about 150 nm. In another aspect, the inventive carbon black can have a mean aggregate particle size of from about 110 nm to about 140 nm. In another aspect, the inventive carbon black can have a mean aggregate particle size of from about 115 nm to about 130 nm. In another aspect, the inventive carbon black can have a mean aggregate particle size of from about 115 nm to about 125 nm. In another aspect, the inventive carbon black can have a mean aggregate particle size of from about 115 nm to about 120 nm.

In one aspect, the inventive carbon black can have an aggregate size distribution D50 ranging from about 100-150 nm. In another aspect, the inventive carbon black can have an aggregate size distribution D50 ranging from about 110-140 nm. In another aspect, the inventive carbon black can have an aggregate size distribution D50 ranging from about 115-130 nm. In another aspect, the inventive carbon black can have an aggregate size distribution D50 ranging from about 115-125 nm. In another aspect, the inventive carbon black can have an aggregate size distribution D50 ranging from about 115-120 nm.

In one aspect, the inventive carbon black can have an aggregate size distribution D10 ranging from about 60-90 nm. In another aspect, the inventive carbon black can have an aggregate size distribution D10 ranging from about 70-85 nm. In another aspect, the inventive carbon black can have an aggregate size distribution D10 ranging from about 75-85 nm. In another aspect, the inventive carbon black can have an aggregate size distribution D10 ranging from about 75-80 nm.

In one aspect, the inventive carbon black can have an aggregate size distribution D90 ranging from about 150-200 nm. In another aspect, the inventive carbon black can have an aggregate size distribution D90 ranging from about 160-200 nm. In another aspect, the inventive carbon black can have an aggregate size distribution D90 ranging from about 160-190 nm. In another aspect, the inventive carbon black can have an aggregate size distribution D90 ranging from about 165-190 nm. Aggregate size and distribution data can be measured as described in ISO Standard 15825-2017 “Rubber Compounding Ingredients-Carbon Black-Determination of Aggregate Size Distribution by Disk Centrifuge Photosedimentometry,” International Organization for Standardization, Geneva (2017).

In some aspects, the carbon blacks can be functionalized with many different chemical moieties, ranging from adsorbed molecules, oligomer grafts, and specific functional groups that are covalently bonded. This functionalization is generally believed to occur on the edge sites of graphene planes at the surface of the carbon black. For various applications, it has become important to improve the surface functionality of carbon black with increased surface group concentrations and more uniform surface chemistry, as much as can be realistically obtained. It should also be understood that completely covering the surface of carbon black particles with functional groups may not be necessary and may make the resulting carbon black too reactive and requiring significant energy and highly intensive treatments to add higher and higher levels of functional groups. While not wishing to be bound by theory, it is now believed that an ideal balance is to functionalize each available graphene layer edge site capable of being functionalized.

### C. Elastomeric Compositions

Another aspect of this disclosure relates to elastomeric (e.g., rubber) compositions comprising the inventive carbon blacks. In general the rubber compositions can comprise at least one elastomer and any inventive carbon black as described above.

In one aspect, the elastomeric composition can comprise: an elastomer in an amount of 100 parts per hundred rubber (phr); and the inventive carbon black in an amount ranging from 35 parts per hundred rubber (phr) to 75 parts per hundred rubber (phr).

Any suitable elastomer can be present in the rubber composition. Non-limiting examples include natural rubber (NR), polybutadiene rubber (BR), styrene butadiene rubber (SBR), natural polyisoprene rubber, butyl rubber, ethylene propylene rubber, or any blend or combination thereof. Any of the foregoing elastomers can be present in the rubber combination either alone or in combination in an amount of 100 parts per hundred rubber (phr). In a further aspect, the elastomer comprises natural rubber (NR), polybutadiene rubber (BR), or any blend or combination thereof. In a still further aspect, the elastomer comprises natural rubber (NR) in an amount ranging from 40 to 100 parts per hundred rubber (phr) and polybutadiene rubber (BR) in an amount ranging from 0 to 60 parts per hundred rubber (phr). In another aspect, the elastomer comprises natural rubber (NR) in an amount ranging from 40 to 50 parts per hundred rubber (phr) and polybutadiene rubber (BR) in an amount ranging from 50 to 60 parts per hundred rubber (phr). In a further aspect, the elastomer comprises natural rubber (NR) in an amount of 50 parts per hundred rubber (phr) and polybutadiene rubber (BR) in an amount ranging of 50 parts per hundred rubber (phr).

One embodiment of the elastomeric composition comprises natural rubber (NR), polybutadiene rubber (BR), styrene butadiene rubber (SBR), synthetic polyisoprene rubber, butyl rubber, ethylene propylene rubber, or any blend or combination thereof. Another embodiment comprises natural rubber (NR), polybutadiene rubber (BR), or any blend or combination thereof. The natural rubber (NR) can be present in an amount ranging from 40 to 100 parts per hundred rubber (phr) and the polybutadiene rubber (BR) in an amount ranging from 0 to 60 parts per hundred rubber (phr).

In one aspect, the rubber composition exhibits equal or better properties than a substantially identical reference composition but with the carbon black replaced with ASTM N550 grade carbon black. Embodiments of the inventive rubber compositions, for example, can exhibit a modulus approximately equal to that of the reference composition, 5-10% reduced heat buildup compared to the reference composition, 10-30% increase in tear strength relative to the reference composition, and as much as a 25% reduction in abrasion loss compared to the reference composition.

Also disclosed are articles comprising any inventive rubber composition. Non-limiting examples include any rubber used in a dynamic environment such as tires, rotating belts, extruded profiles, hoses, brake diaphragms, plastic piping, among others.

### D. Methods

Also described are methods of making the inventive rubber compositions. In one aspect, the method comprises: (a) providing an elastomer in an amount of about 100 parts per hundred rubber (phr); (b) providing the inventive carbon black in an amount ranging from 35 parts per hundred rubber (phr) to 75 parts per hundred rubber (phr); and (c) mixing the elastomer and the carbon black to form a rubber composition.

It is understood that the elastomers utilized in the disclosed method can comprise any elastomer described above. It is further understood that these elastomers can be present in any amounts as described herein to provide for the rubber composition exhibiting the disclosed properties. Similarly any oxidized versions of the inventive carbon blacks can be used in any disclosed amounts to prepare the rubber composition exhibiting the disclosed properties.

It is further understood that any types of mixing can be utilized to prepare the inventive rubber composition. In certain aspects, the step of mixing comprises a reactive mixing. In yet other aspects, the step of mixing comprises a conventional step of mixing of ingredients. In still further aspects, the step of mixing comprises blending. In certain aspects, the step of mixing results in homogeneous compositions.

It is understood that the rubber compositions obtained by the methods of the current disclosure can exhibit any or all of the above disclosed properties. In still further aspects, described herein are articles that can be prepared from the rubber composition made by the inventive methods.

### E. Examples

The following examples further illustrate this disclosure. The scope of the disclosure and claims is not limited by the scope of the following examples.

TABLE 1

| | | Reference Products | | | Inventive Carbon Blacks | |
|---|---|---|---|---|---|---|
| | Units | N330 | N339 | N550 | BC2187 | BC2183 |
| Iodine | mg/g | 82 | 90 | 43 | 60 | 50 |
| NSA | m²/g | 78 | 91 | 40 | 60 | 50 |
| STSA | m²/g | 75 | 88 | 39 | 60 | 50 |
| OAN | cc/100 g | 102 | 120 | 121 | 120 | 138 |
| COAN | cc/100 g | 88 | 99 | 85 | 90 | 90 |

Exemplary embodiments of inventive rubber compositions can be prepared according to the loading parameters shown in Table 2.

TABLE 2

| Component | Loading/phr |
|---|---|
| NR (SVR CV60) | 100 |
| Carbon Black | 50 |
| Stearic Acid | 3 |
| Zinc Oxide | 5 |
| TBBS | 0.6 |
| Sulfur | 2.5 |

The aggregate size distribution properties of the inventive carbon blacks as measured by disc centrifuge photosedimentometry are shown in Table 3.

TABLE 3

| Test Item | Unit | BC2187 | BC2183 |
|---|---|---|---|
| Mean | nm | 118 | 120 |
| Aggregate | | | |
| Size | | | |
| Mode | nm | 105 | 107 |
| ΔD50 | nm | 69 | 67 |
| ΔD50/Mode | — | 0.662 | 0.628 |
| D10 | nm | 75 | 79 |
| D50 | nm | 111 | 113 |
| D90 | nm | 167 | 169 |
| Span | — | 0.820 | 0.783 |

Table 4 shows additional comparisons between rubber compositions (prepared according to Table 2 specifications) comprising inventive carbon blacks or N330, N339, and N550 carbon blacks.

TABLE 4

| Rubber Property | | | | | | ASTM Test |
|---|---|---|---|---|---|---|
| Normalized to N550 | N550 | BC2183 | BC2187 | N330 | N339 | Method Ref. |
| Modulus, M100 | 1.00 | 1.11 | 1.00 | 0.88 | 0.99 | D412 |
| Tear Strength, Tc | 1.00 | 0.74 | 1.18 | 1.45 | 1.45 | D624 CP¹ |
| Flexural Heat buildup | 1.00 | 0.92 | 0.92 | 1.21 | 1.24 | D623² |
| Abrasion Loss | 1.00 | 0.85 | 0.83 | 0.90 | 0.80 | D5963 |

¹Room temperature.
²Heat buildup after 25 minutes from room temperature.

Versus N550, BC2187 provides equal modulus, an approximately 8% reduced heat buildup, an approximately 20% increase in tear strength, and an approximately 20% reduction in abrasion loss. In comparison, BC2183 provides a similar benefit in heat buildup. BC2187 is a match for N550 in terms of M100 modulus. In contrast, the ASTM N300-series materials, while having higher tear strength, suffer from an approximately 20%-25% increases in heat buildup.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other methods and systems for carrying out the several purposes of this disclosure. As a result, the claims should not be considered as limited by the description or examples.

What is claimed is:

1. A carbon black having the following properties:
a) a nitrogen surface area (NSA) ranging from about 50 m²/g to about 70 m²/g;
b) a statistical thickness surface area (STSA) ranging from about 50 m²/g to about 70 m²/g c) an iodine absorption number ranging from about 50 mg/g to about 70 mg/g;
d) an oil absorption number (OAN) ranging from about 85 cc/100 g to about 150 cc/100 g; and
e) a compressed oil absorption number (COAN) ranging from about 70 cc/100 g to about 100 cc/100 g.

2. The carbon black of claim 1, wherein the nitrogen surface area (NSA) and the statistical thickness surface area (STSA) differ by no more than 5%.

3. The carbon black of claim 2, wherein the iodine absorption number and at least one of the nitrogen surface area (NSA) or the statistical thickness surface area (STSA) differ by no more than 5%.

4. The carbon black of claim 1, having a nitrogen surface area (NSA) ranging from about 55 m²/g to about 65 m²/g.

5. The carbon black of claim 1, having a statistical thickness surface area (STSA) ranging from about 55 m²/g to about 65 m²/g.

6. The carbon black of claim 1, having an iodine absorption number ranging from about 55 mg/g to about 65 mg/g.

7. The carbon black of claim 1, having an oil absorption number (OAN) ranging from about 90 cc/100 g to about 145 cc/100 g.

8. The carbon black of claim 1, having a compressed oil absorption number (COAN) ranging from about 75 cc/100 g to about 95 cc/100 g.

9. The carbon black of claim 1, having the following properties:
a) a nitrogen surface area (NSA) ranging from about 55 m²/g to about 65 m²/g;
b) a statistical thickness surface area (STSA) ranging from about 55 m²/g to about 65 m²/g;
c) an iodine absorption number ranging from about 55 mg/g to about 65 mg/g;
d) an oil absorption number (OAN) ranging from about 90 cc/100 g to about 145 cc/100 g; and
e) a compressed oil absorption number (COAN) ranging from about 75 cc/100 g to about 95 cc/100 g.

10. The carbon black of claim 9, wherein the nitrogen surface area (NSA) and the statistical thickness surface area (STSA) differ by no more than 5%.

11. The carbon black of claim 10, wherein the iodine absorption number and at least one of the nitrogen surface area (NSA) or the statistical thickness surface area (STSA) differ by no more than 5%.

12. A elastomeric composition comprising at least one elastomer and the carbon black of claim 1.

13. An elastomeric composition comprising:
a) an elastomer in an amount of 100 parts per hundred rubber (phr); and
b) the carbon black of claim 1 in an amount ranging from 35 parts per hundred rubber (phr) to 75 parts per hundred rubber (phr).

14. The elastomeric composition of claim 13, wherein the elastomer comprises natural rubber (NR), polybutadiene rubber (BR), styrene butadiene rubber (SBR), synthetic polyisoprene rubber, butyl rubber, ethylene propylene rubber, or any blend or combination thereof.

15. The elastomeric composition of claim 13, wherein the elastomer comprises natural rubber (NR), polybutadiene rubber (BR), or any blend or combination thereof.

16. The elastomeric composition of claim 15, wherein the elastomer comprises natural rubber (NR) in an amount ranging from 40 to 100 parts per hundred rubber (phr) and polybutadiene rubber (BR) in an amount ranging from 0 to 60 parts per hundred rubber (phr).
